(19) United States
(12) Patent Application Publication
(10) Pub. No.: US 2019/0173348 A1
(43) Pub. Date: Jun. 6, 2019

(54) Wire Passthrough Stator

(71) Applicant: Massoud Sadeghi, Newcastle, WA (US)

(72) Inventor: Massoud Sadeghi, Newcastle, WA (US)

(21) Appl. No.: 15/832,764

(22) Filed: Dec. 5, 2017

(51) Int. Cl. H02K 3/50

(52) U.S. Cl. CPC H02K 3/50; B64D 37/32; H02K 2203/06

(57) ABSTRACT

Electrical faults within machines used in flammable environments can cause catastrophic events. For this reason, a great deal of attention has been placed to mitigate the cause and effects of arcs and sparks within these flammable environments. For example, the Federal Aviation Administration has imposed requirements to insure fuel tank safety and mitigate ignition sources within components related to the fuel system. Wire routing within a fuel pump has been of great concern for manufactures, operators, and aviation regulators for quite some time. Other industries such as automotive, mining, petroleum, and chemical refineries also struggle to ensure their electrical machines do not impose an unsafe condition due to an electrical fault. Introducing this new stator design within an electric machine will provide safety features necessary to mitigate ignition sources and to comply with regulations.

The Wire Passthrough Stator routes wires directly through the stator core through a wire passage (as shown in FIGS. 2 and 3). The Wire Passthrough Stator core can include a single wire passage or multiple passages (as shown in FIGS. 2 and 3). Electrical connections through the wire passage(s) can be made via wires/bars, connectors, splices, soldering joints, crimps and/or a continuous wire run (examples are depicted in FIGS. 4 and 5). This Wire Passthrough Stator is applicable to any electric machine consisting of a stator core (motors, generators, alternators, pumps, etc.)

### CROSS-REFERENCE

Provisional Patent Application Number: 62/565,104

Filing Date: Sep. 29, 2017

Confirmation Number: 4931

### BACKGROUND

A stator is the stationary part of an electrical machine which produces the electromagnetic field (in the case of a motor) or electrical power (in the case of a generator/alternator). The stator consists of a core, windings, and electrical leads. They are used for both alternating and direct current applications with single or multi-phase power systems. The possibility of an electrical machines failing and posing an ignition source has been of a great concern in the industry, especially in applications where flammable vapors exist. For example, sparks/arcs in an aircraft's fuel pump due to faults within the pump's wiring will put the aircraft and its occupants at great risk. Faults within the fuel pump can lead to an ignition source within the fuel system which would result in a catastrophic event. Other industries take similar precautions to electrical machines within flammable environments such as mining, petroleum, and chemical refineries.

To reduce the possibilities of a catastrophic condition for an aircraft, aviation authorities have imposed requirements which require multiple protective layers to all electric machines used within an aircraft's fuel system. To prevent impairment of the explosion proneness of the fuel pump, mandatory integration of Ground Fault Interrupters (GFI) are among the imposed requirements. Direct compliance to these requirements has greatly burdened both the manufactures and operators.

### SUMMARY OF THE INVENTION

The Wire Passthrough Stator eliminates the need for electrical routing inside the electric machines. In this stator design the electrical leads for the input/output power exit directly from stator core without any exposure to machine's inside environment. As a result, ignition sources from faults caused by input/output leads will be eliminated. This stator increases the reliability of the electrical machine by removing failure modes associated with the wire routing inside the machine.

The Wire Passthrough Stator will increase aircraft safety, reliability of electrical machines, and reduce an operator's operation/maintenance cost in comparison to traditional stator designs being used.

### DESCRIPTION OF DRAWINGS/FIGURES

FIG. 1. The construction of the Wire Passthrough Stator for a single passthrough where all wire(s) from the stator exit through a single passage.

FIG. 2. The construction of the Wire Passthrough Stator for multiple passthroughs where the wires from the stator exit through multiple passages. In this configuration, wires can pass through the passages individually or in groups.

FIG. 3. The construction of the Wire Passthrough Stator for a single passthrough where all wires from the stator exit through a single passage and in a bundle.

FIG. 4. The construction of the Wire Passthrough Stator with a connection/connector mechanism.

FIG. 5. Current Stator design which is commonly used in electric machines. Wire leads are attached to the winding and routed inside the machine to a connector.

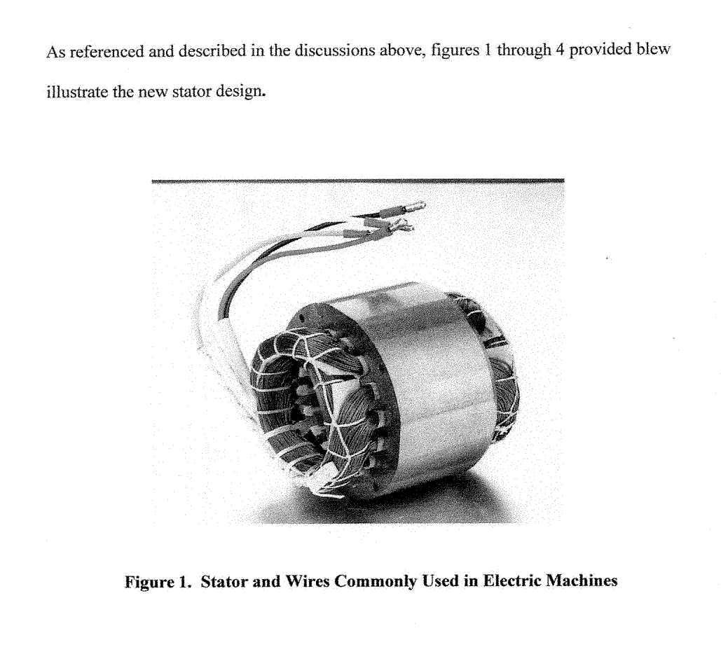

### DETAIL DESCRIPTION OF THE INVENTION

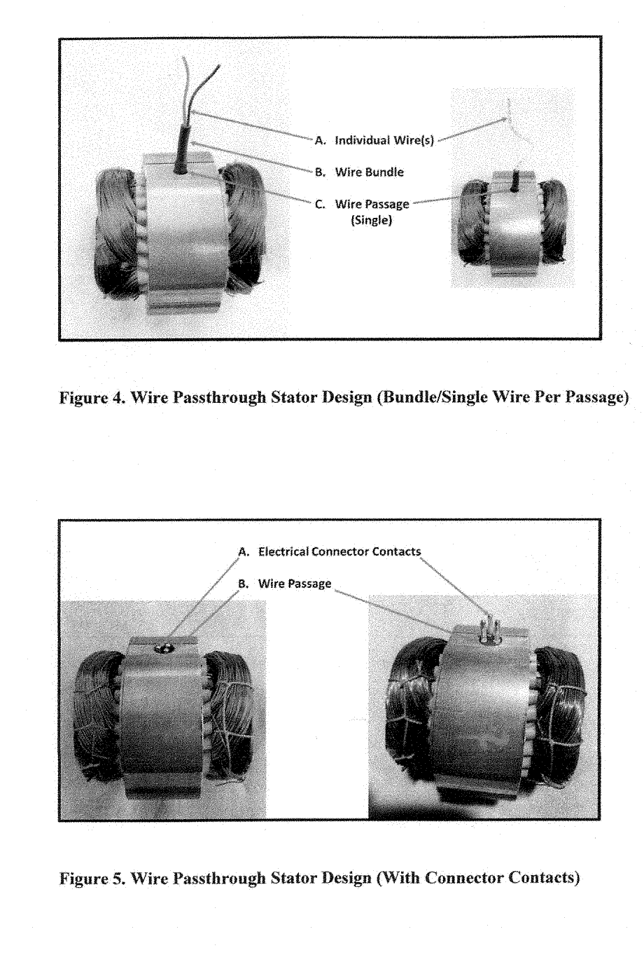

FIG. 4 depicts the stator design commonly used in current electric machines. As shown in this figure, the electrical wire leads are attached to the windings. These wires are routed inside the electrical machine and connected to the electrical connector for an external connection. Electrical wires routed inside electrical machines are vulnerable to faults and failures due to vibration, chafing, mechanical stress, aging, flaws, etc. To prevent the development of ignition sources as the results of faults and failures within wires routed inside electric machines, manufactures/operators have implemented various mechanisms, including multiple layers of protection inside their machines. In many cases, the added protective mechanisms do not provide adequate protection and add complexity to the overall system which could negatively impact the reliability and safety.

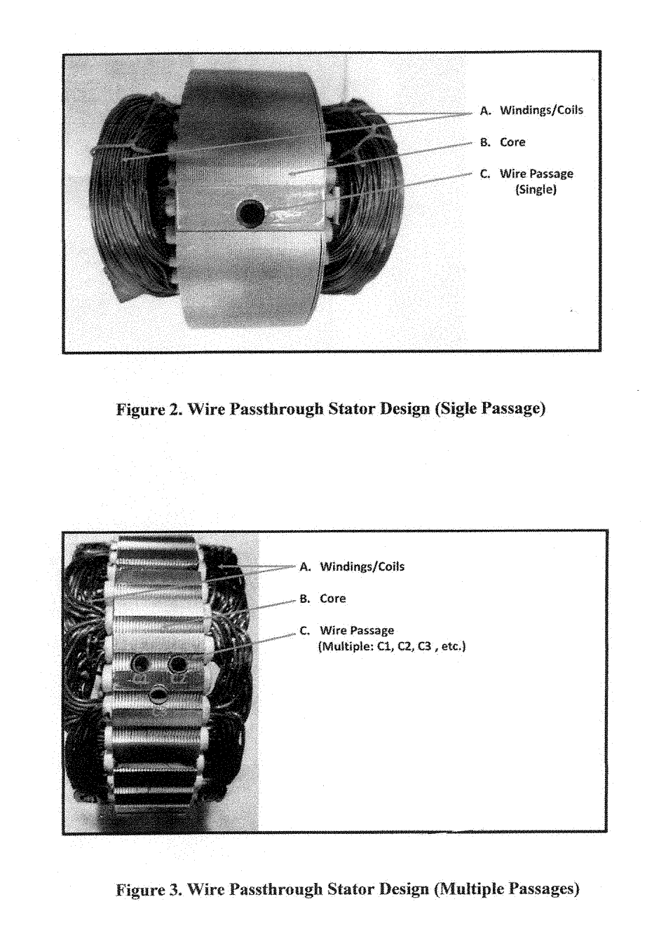

In contrast, as shown in FIGS. 2 to 5, in the Wire Passthrough Stator, the wires pass through the stator core without any need for routing inside the machine. Wires exit the machine without the need of an interface with the machine's internal environment. Thus, ignition sources due to faults and failures within routed wiring inside the machines are eliminated.

The Wire Passthrough Stator routes wires directly through the stator core through a single passage or multiple passages (examples are shown in FIGS. 2 and 3). Electrical connections through the wire passage(s) can be made via wires/bars, connectors, splices, soldering joints, crimps and/or a continuous wire run (examples are depicted in FIGS. 4 and 5). The Wire Passthrough Stator is applicable to any electric machine consisting of a stator core such as motors, generators, alternators, and pumps.

1-7. (canceled)

8. The stator core of electric machine contains a passage or multiple passages. Electrical connections through the passage(s) can be made via wires/bars, connectors, splices, soldering joints, crimps and/or a continuous wire run.
